(19) United States
(12) Patent Application Publication
(10) Pub. No.: US 2008/0069652 A1
(43) Pub. Date: Mar. 20, 2008

(54) Spot Weld Drill

(75) Inventor: Shigeki Kobayashi, Nagano (JP)

Correspondence Address: SENNIGER POWERS LLP, ONE METROPOLITAN SQUARE, 16TH FLOOR, ST LOUIS, MO, 63102, US

(73) Assignee: SP AIR KABUSHIKI KAISHA, Nagano (JP)

(21) Appl. No.: 11/531,884

(22) Filed: Sep. 14, 2006

(51) Int. Cl. B23B 47/22

(52) U.S. Cl. 408/130

(57) ABSTRACT

A drill tool for removing a spot weld from metal includes a housing, a motor mounted in the housing in fixed position relative to the housing, and a bit assembly supported by the housing for movement relative to the housing and the motor between an extended position and a retracted position. The bit assembly is operatively connected to the motor so that the motor can drive rotation of the bit assembly in the extended position.

### BACKGROUND OF THE INVENTION

The invention relates generally to power driven tools, and more particularly to a power driven tool for removing spot welds joining metal surfaces together.

Spot welds are commonly used to join pieces of metal (typically thin pieces up to 0.12 in (3 mm) thick). This is particularly true in the automobile industry where prefabricated sheets of metal and structural elements are joined to form a body of an automobile. The pieces of metal are laid together in flat contact, and two small diameter electrodes are positioned on opposite sides of the pieces at a desired spot weld location. The electrodes are pressed together and an electric current passes between them. The current heats the pieces of metal at the spot of the electrodes and slightly melts the metal. The spots of molten metal fuse together in the vicinity of the electrodes and join the pieces of metal.

It occasionally becomes necessary to separate pieces of metal that have been spot welded together. For example in the automobile industry, it may be necessary to remove a damaged fender panel or door panel from an underlying frame. An effective method to accomplish this is drilling through the outer piece of metal at each of the spot weld locations. The outer piece of metal can be removed and the underlying piece can be reused.

Efficiently drilling through an outer piece of metal requires applying high pressure to the drill and bit to cleanly cut through the metal. An operator alone may not manually be able to apply enough pressure to accomplish this. Therefore, it is desirable for the drill to be constructed to provide additional force to the bit independent of the operator.

It is known to use air pressure to supply force to a bit to assist drilling out spot welds. The air pressure seats the bit against an outer piece of metal and provides force to the bit to help cut through the metal. However, the bit is relatively rigidly connected to a motor for operation so that the motor moves conjointly with the bit when the drill moves into and out of contact with the piece of metal. It would be desirable to provide a drill for removing spot welds in which additional force can be applied to a bit independent of an operator without longitudinally moving a motor within the drill.

### SUMMARY OF THE INVENTION

The invention is directed to a drill tool for removing a spot weld. The tool generally comprises a housing, a motor mounted in the housing in fixed position relative to the housing, and a bit assembly supported by the housing for movement relative to the housing and the motor between an extended position and a retracted position. The bit assembly is operatively connected to the motor so that the motor can drive rotation of the bit assembly in the extended position.

In another aspect of the invention, the drill tool comprises the housing, the motor, which is a pneumatic motor, and the bit assembly. The drill tool also comprises an air chamber defined in the housing generally between the bit assembly and the pneumatic motor for applying air pressure to the bit assembly for moving the bit assembly to the extended position. A drive shaft assembly interconnects the pneumatic motor and the bit assembly to permit transfer of rotational motion from the motor to the bit assembly and to permit translational movement of the bit assembly relative to the motor.

### Other features of the invention will be in part apparent and in part pointed out hereinafter.

### BRIEF DESCRIPTION OF THE DRAWINGS

FIG. 1 is a side elevation of a spot weld drill of the present invention;

FIG. 2 is a longitudinal section thereof with a C-arm of the drill removed;

FIG. 3 is an exploded longitudinal section of a bit assembly and an output shaft of a drive shaft assembly of the drill;

FIG. 4 is a side elevation of the drill in position to remove a spot weld connection between two pieces of metal;

FIG. 5 is the side elevation of FIG. 4 with the spot weld connection removed; and

FIG. 6 is an enlarged, fragmentary longitudinal section of the drill illustrating air flow through the drill.

Corresponding reference characters indicate corresponding parts throughout the views of the drawings.

### DETAILED DESCRIPTION

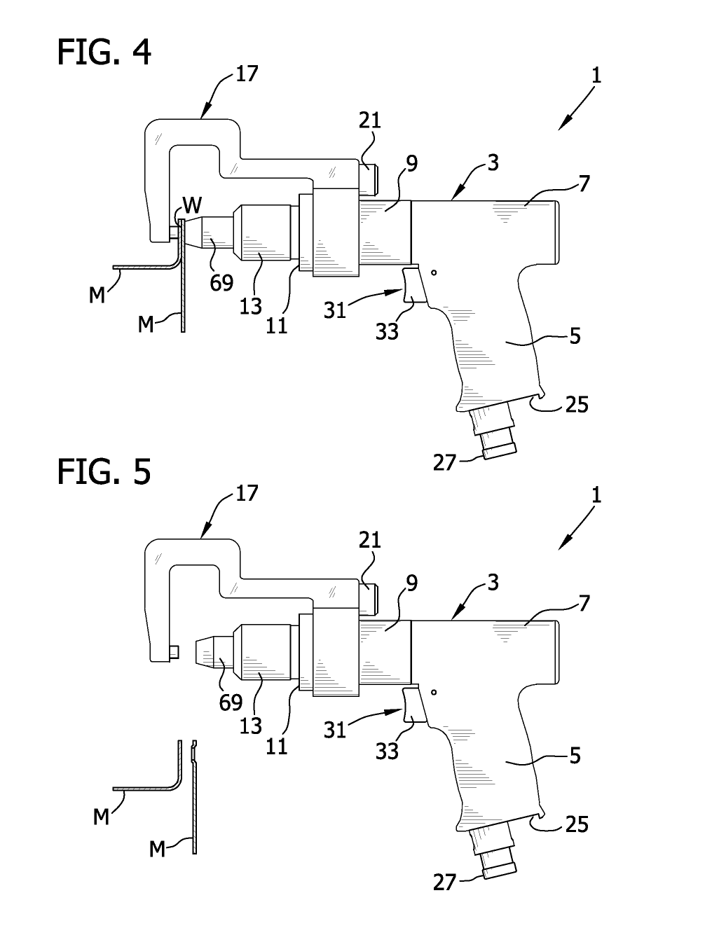

Referring now to the drawings, a pneumatic spot weld drill (broadly, a “drill tool”) according to the general principals of the present invention is indicated generally at 1. The drill 1 is capable of removing a spot weld W from pieces of metal M that have been spot welded together (See, FIGS. 4 and 5).

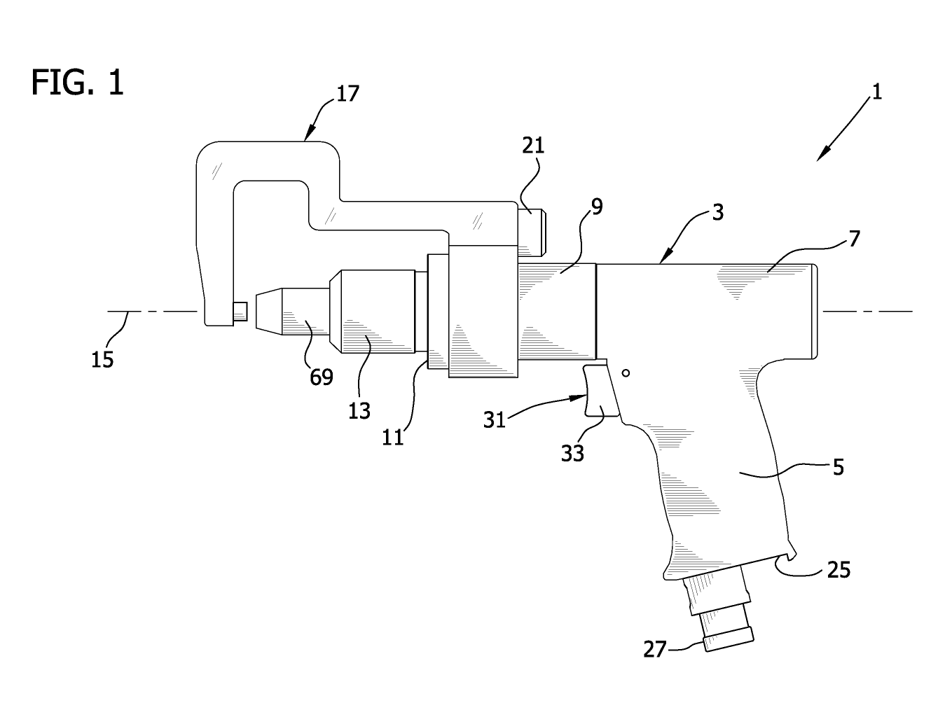

As shown in FIG. 1, the drill 1 has a pistol-shaped housing, indicated generally at 3, which allows an operator to comfortably grasp and operate the drill 1. In the illustrated drill 1, the housing 3 comprises a handle 5 and an upper sleeve assembly connected to the handle for ease of manufacturing and assembly. The sleeve assembly includes tubular sleeves 7, 9, 11, and 13 joined together so that a longitudinal axis 15 extends centrally through each sleeve. A one-piece housing and a housing with a differing number of components are within the scope of the invention.

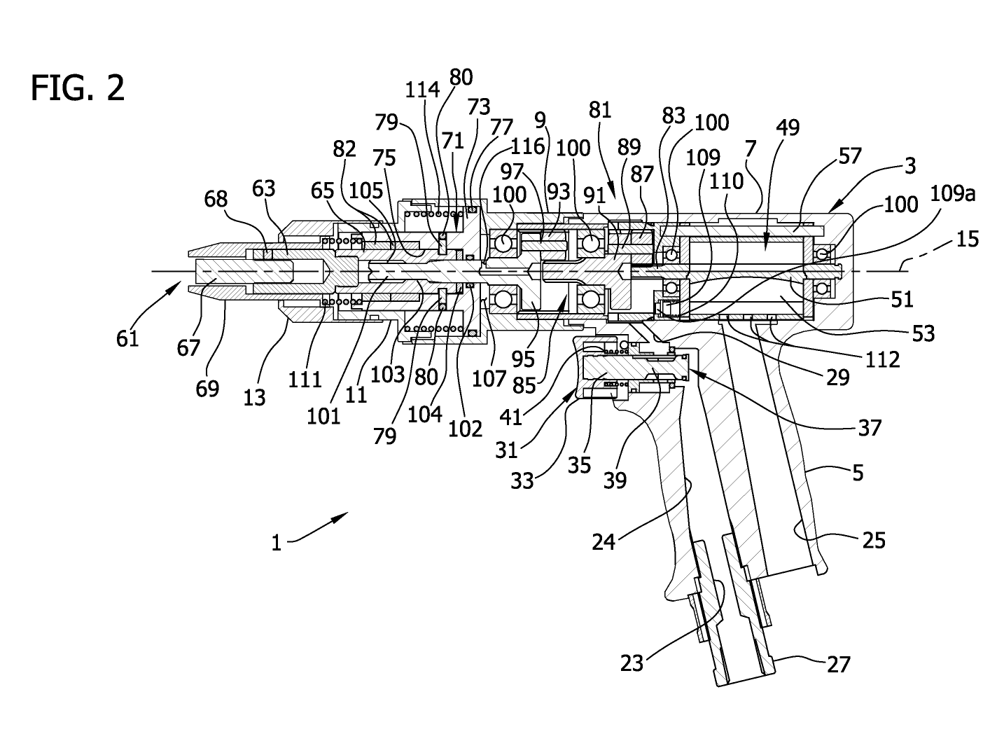

A C-arm, indicated generally at 17, is mounted on sleeve 9 of the housing 3 to provide a reaction surface for drilling during operation (also see FIG. 4). The C-arm 17 can rotate on the sleeve 9. A cap 21 is connected to the C-arm 17 to hold the C-arm against the sleeve 9 and to prevent translational movement of the C-arm 17 along the sleeve 9. The cap 21 has a flat edge (not shown in FIG. 1) that can be rotated to a bottom position as viewed in FIG. 1 when it is desired to remove the C-arm 17 from the drill 1. This allows the C-arm to slide forward and off of sleeve 9 (see FIG. 2, which further shows the shape of sleeve 9). A drill without a C-arm is within the scope of the invention.

As shown in FIG. 2, within the handle 5 of the housing 3 are located an intake fitting 27, an air intake channel 24, and an air exhaust manifold 25. The intake fitting 27 includes a bore 23 that extends through the fitting. The air intake channel 24 extends substantially the length of the handle 5 from the fitting 27 to an airway channel 29 at the top of the handle. The intake fitting 27 is a conventional fitting shaped to connect the drill 1 to a hose of an air compressor (not shown) and may be a threaded fitting or a quick release fitting, both known in the art. The air exhaust manifold 25 is rearward of the intake fitting 27 and channel 24 and also extends substantially the length of the handle 5. The manifold 25 is open at both the top and bottom of the handle 5 to expel air spent by the drill 1 during operation.

A trigger assembly 31 is located toward the top of the handle 5 and adjacent the airway channel 29. The trigger assembly 31 includes a trigger 33 mounted on the handle 5 by a cylindrical trigger mount 35, and a trigger valve, indicated generally at 37 and known in the art, connected to the trigger mount 35 by a stem 39. The trigger 33 operates the trigger valve 37 for controlling air flow through the air intake channel 24 to the airway channel 29. When the trigger 33 is depressed, the valve 37 opens and air flows through the valve to the airway channel 29. When the trigger 33 is released, the valve 37 closes and blocks air from flowing. A compression spring 41 positioned around the trigger mount 35 biases the trigger 33 from its depressed position to the released position when the drill 1 is inactive, thus holding the valve 37 closed.

The drill 1 includes a pneumatic rotary motor 49 having a rotor 51 and vanes 53, as is known in the art, mounted in a rear end of the housing 3 for operating the drill 1. It is to be understood that other types of motors, for example electric motors, could be used and still be within the scope of the present invention. The motor 49 is secured to the housing 3 and is fixed against translational movement lengthwise of the housing 3 and against rotational movement relative to the housing. Pins 57 support the motor 3.

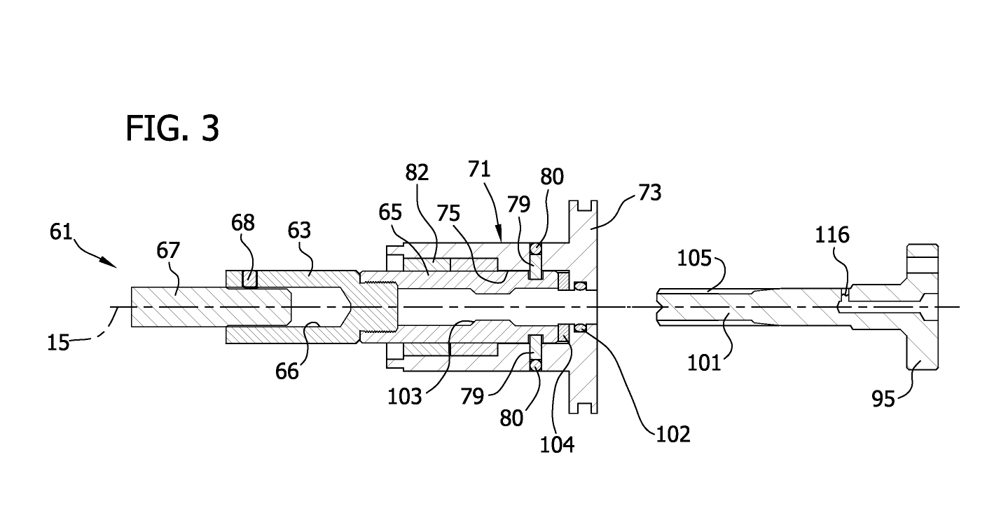

A bit assembly, indicated generally at 61, is located at the forward end of the drill 3 and is operably connected to the motor for driven rotation. As can be seen in FIG. 3, the bit assembly 61 is cylindrical in shape and includes a chuck 63 and an input sleeve 65, each of which are about the same diameter. The chuck 63 is located forward of the sleeve 65 and is connected to the sleeve by, for example, a threaded connection for conjoint rotation of the chuck 63 and sleeve 65. The chuck 63 may be connected differently to the sleeve 65 within the scope of the invention. The chuck 63 has a central opening 66 therein that receives a bit 67, for example an end mill, as is known in the art to allow easy insertion and removal of the bit and secured joint rotation of the bit with the chuck. For example, the bit may be secured by a set screw 68. It is to be understood that the bit may also be a drill bit, or any other type of bit used in the art, within the scope of the invention.

Referring again to FIG. 2, the chuck 63 and bit 67 extend out of the front of the housing 3 and into a bit shield 69. The shield fits partly within the sleeve 11 of the housing 3 and extends out of the housing over the chuck 63 and bit 67. The shield 69 is slidably connected to the housing 3 and is slidably fitted over the chuck 63 and bit 67 so that it can move lengthwise of the housing 3 relative to each of the housing 3, the chuck 63, and the bit 67 during operation.

As shown in FIGS. 2 and 3, a tubular piston, indicated generally at 71, is located to the rear of the bit assembly 61. The piston 71 has a rear push plate 73 larger in diameter than the rest of the piston and a central opening 75 extending through the piston. An O-ring 77 extends around the periphery of the push plate 73 to seal it against an inner wall of the sleeve 9 of the housing 3 for airtight movement. The push plate 73 may be formed as one piece with the piston 71 (as shown) or it may be attached separately. The piston 71 receives the input sleeve 65 of the bit assembly 61 in the central opening 75 and is connected to the sleeve just forward of the push plate 73 by a pin 79 and an O-ring 80. This connection holds the bit assembly 61 together with the piston 71 for conjoint translational movement lengthwise of the housing 3, but allows the bit assembly to rotate relative to the piston during operation. The input sleeve 65 is also supported in the central opening 75 by needle bearings 82.

A drive shaft assembly, indicated generally at 81, connects the bit assembly 61 to the motor 49. The drive shaft assembly 81 includes a motor output shaft 83 and a planetary gear assembly generally at 85 which is located between the motor 49 and piston 71. The output shaft 83 transfers rotational speed from the motor 49 in known fashion to the planetary gear assembly 85, and the planetary gear assembly reduces the rotational speed and increases the torque from the motor output shaft 83 and imparts the reduced speed and increased torque to the bit assembly 61.

The motor output shaft 83 engages a first planet gear 87 at a spline connection so that rotation of the output shaft 83 causes the planet gear 87 to orbit around the shaft 83. The planet gear 87 rotatably connects to a first drive gear 91 at pin 89 so that as it orbits the motor output shaft 83, it conjointly rotates the first drive gear 91. A second planet gear 93 and drive gear 95 are similarly connected by pin 97 so that rotation of the first drive gear 91 rotates an output shaft 101 of the second drive gear 95. Bearings 100 are provided to support rotational movement of the components.

The output shaft 101 extends from the second drive gear 95 through the piston 71 and connects to the input sleeve 65 of the bit assembly 61 at a spline connection. With reference to FIG. 3, a first set of splines 103 located on the inside surface of the input sleeve 65 mesh with a second set of splines 105 located around an outer surface of the output shaft 101 to transfer rotational motion from the motor 49 to the bit assembly 61. The second set of splines 105 around the output shaft 101 extend lengthwise along the output shaft to allow translational movement of the input sleeve 65 lengthwise relative to the output shaft 101 and motor 49 while still maintaining a rotational connection. An O-ring 102 between the output shaft 101 and piston 71 seals these components together while allowing the shaft to rotate relative to the piston and the piston to slide axially along the shaft. A thrust washer 104 provides a low friction contact of the input sleeve 65 and piston for transfer of force from the piston to the input sleeve 65 to move the sleeve forward.

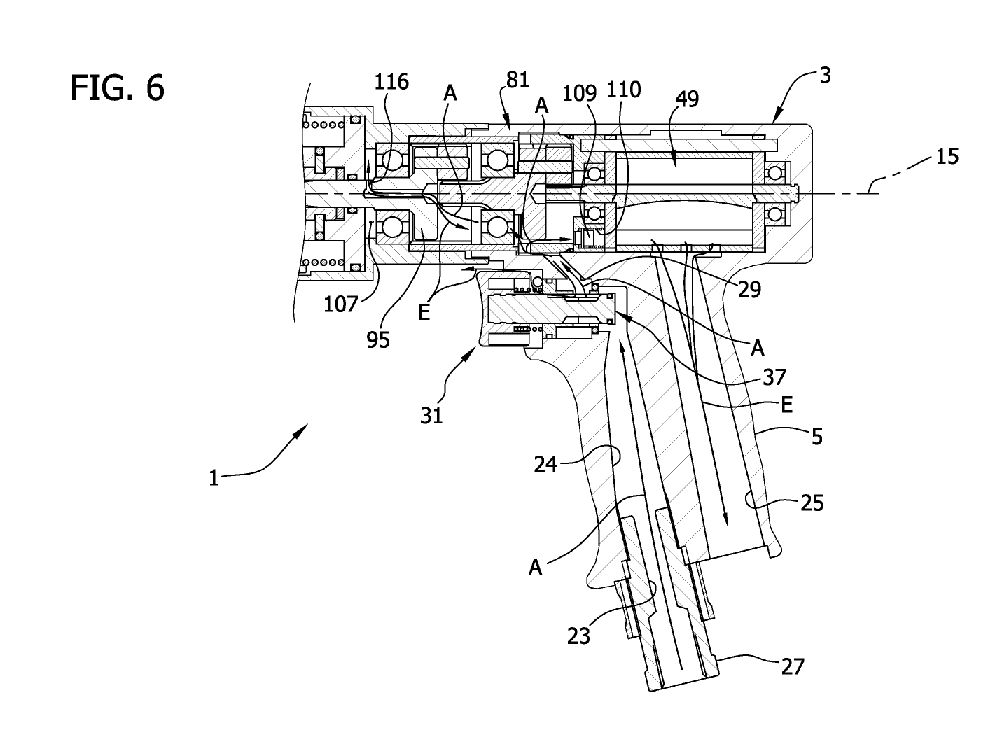

Referring again to FIG. 2, an air chamber 107 is defined in the housing 3 generally between the bit assembly 61 and the motor 49. In particular, the air chamber 107 is defined on one side by the push plate 73 of the piston 71 and on the other side by the motor 49 so that the gear assembly 85 is generally contained within the chamber 107. The air chamber 107 connects to the air intake channel 24 by the airway channel 29 toward the bottom of the air chamber 107 so that air can flow to the chamber 107 during operation (see FIG. 6). A control valve 109 known in the art is located within the air chamber 107 adjacent the motor 49. The valve 109 selectively allows air to flow from the air chamber 107 to the motor 49 when a desired air pressure is achieved in the chamber 107, for example 50 pounds per square inch. More specifically, the valve 109 includes a plug 109a operated by a spring 110 which urges the plug away from the motor 49 to the closed position. As pressure builds in the air chamber 107, the plug 109a moves toward the motor 49 against the urge of the spring 110 and allows air to flow to the motor.

Operation of the drill 1 will now be described. In FIGS. 4 and 5, the drill 1 is shown in position to remove a spot weld W from two pieces of metal M joined together. When the trigger 33 is depressed, the trigger valve 37 opens and air flows (FIG. 6) from the intake fitting 27 and channel 24, through the airway channel 29, through an opening 116 in the drive gear 95, and into the air chamber 107. In FIG. 6, air flowing into the tool is indicated by arrows “A” and air exiting the tool is indicated by arrows “E”. With reference also to FIG. 2, air pressure in the chamber 107 moves the piston 71 and bit assembly 61 connected thereto away from the motor 49, from a retracted position to an extended position. The splined connection between the input sleeve 65 of the bit assembly 61 and the output shaft 101 of the gear assembly 85 allows the input sleeve 65 to slide lengthwise along the output shaft 101.

As the piston 71 and bit assembly 61 move to the extended position, they push the bit shield 69 therewith using a support spring 111 (FIG. 2) loosely connected between the bit shield and piston 71. The shield 69 stops moving once it contacts a facing surface of the joined pieces of metal M (FIG. 4), but the piston 71 and bit assembly 61 continue moving within the shield 69 (compressing the support spring 111) until the bit 67 contacts the facing surface to apply pressure to the facing surface. The C-arm 17 supports the facing surface of the joined pieces of metal M and provides a reaction surface against which the bit 67 can push to drill out the spot weld W.

When the piston 71 and bit assembly 61 stop moving, pressure builds in the air chamber 107 until a predetermined pressure, for example 50 pounds per square inch, is reached, at which time the motor control valve 109 opens against the urge of spring 110. Air moves from the air chamber 107 and into the motor 49 and drives the motor to rotate the gear assembly 85 and bit assembly 61 (and bit 67). Air spent through the motor 49 is expelled from the drill 1 by motor vents 112 into the exhaust manifold 25. The air pressure behind the piston 71 remains fairly constant during this operation and provides desirable additional cutting force to the bit 67.

When the trigger 33 is released, the trigger valve 37 closes and air stops moving to the air chamber 107. Air initially vents through the motor vents 112 to the exhaust manifold 25 (FIG. 6). But when the motor control valve 109 closes, the remaining air in the air chamber 107 moves back through the airway channel 29 and vents at the trigger (FIG. 6). As pressure in the air chamber 107 drops, a piston spring 114 seated forward of the piston push plate 73 pushes the piston 71 and bit assembly 61 toward the motor 49 and back to the retracted position. The support spring 111 holds the bit shield 69 against the facing surface for an instant as the bit 67 retracts. The shield 69 then moves with the piston 71 and bit assembly 61.

While the above invention is described as a pneumatic tool, it is envisioned that the invention could be accomplished using an electric tool. For example, the piston 71 may be powered by a first electric motor (not shown). When the trigger 33 is depressed, the first electric motor powers the piston 71 to move the bit assembly 61 from the retracted position to the extended position. Once the bit assembly 61 reaches the extended position, a second electric motor (not shown) may be activated to rotate the gear assembly 85 and bit assembly 61. When the trigger 33 is released, the first motor is deactivated and cuts power to the piston 71. The piston spring 114 moves the piston 71 and bit assembly 61 back to the retracted position. This deactivates the second motor and immediately stops rotational input to the drill assembly. Use of a single electric motor is also within the scope of the invention. Additionally, other forms of operating the drill 1 of the invention may be used within the scope of the invention.

In view of the above, it will be seen that the several features of the invention are achieved and other advantageous results obtained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A drill tool for removing a spot weld, the tool comprising:
a housing;
a motor mounted in the housing in fixed position relative to the housing;
a bit assembly supported by the housing for movement relative to the housing and the motor between an extended position and a retracted position;
the bit assembly being operatively connected to the motor so that the motor can drive rotation of the bit assembly in the extended position.

2. A drill tool as set forth in claim 1 further comprising a drive shaft assembly interconnecting the motor and the bit assembly to permit transfer of rotational motion from the motor to the bit assembly and to permit translational movement of the bit assembly relative to the motor.

3. A drill tool as set forth in claim 2 wherein the drive shaft assembly and bit assembly have a splined interconnection.

4. A drill tool as set forth in claim 3 wherein the drive shaft assembly comprises a gear assembly operatively connecting the motor to the bit assembly for reducing rotational speed imparted from the motor to the bit assembly, the bit assembly moving away from the gear assembly when moving to the extended position.

5. A drill tool as set forth in claim 4 wherein the bit assembly includes a chuck for receiving a bit to remove a spot weld.

6. A drill tool as set forth in claim 1 further comprising an air chamber defined in the housing generally between the bit assembly and the motor for applying air pressure to the bit assembly for moving the bit assembly to the extended position.

7. A drill tool as set forth in claim 6 further comprising a piston defining at least a portion of the air chamber.

8. A drill tool as set forth in claim 7 further comprising an air intake, the air intake introducing air into the air chamber when the drill tool is activated, the air introduced into the air chamber causing the piston to move the bit assembly to the extended position.

9. A drill tool as set forth in claim 8 wherein the motor is a pneumatic motor, air from the air intake driving the pneumatic motor to power the bit assembly after the piston moves the bit assembly to the extended position.

10. A drill tool as set forth in claim 9 further comprising a return spring, the return spring moving the piston and bit assembly from the extended position to the retracted position when the drill tool is deactivated and air ceases moving from the air intake into the air chamber.

11. A drill tool as set forth in claim 7 wherein the bit assembly is coupled to the piston to allow conjoint movement of the piston and bit assembly in the longitudinal direction of the housing independent of the motor and to allow rotational movement of the bit assembly relative to the piston.

12. A drill tool as set forth in claim 6 further comprising at least one gear element disposed in the air chamber and operatively connecting the motor to the bit assembly, the gear having a gear and a shaft extending forward from the gear and an opening formed in the shaft between a free end of the shaft and the gear for allowing air to move through the shaft.

13. A drill tool for removing a spot weld, the tool comprising:
a housing;
a pneumatic motor mounted in the housing in fixed position relative to the housing;
a bit assembly supported by the housing for movement relative to the housing and the motor between an extended position and a retracted position;
an air chamber defined in the housing generally between the bit assembly and the pneumatic motor for applying air pressure to the bit assembly for moving the bit assembly to the extended position;
a drive shaft assembly interconnecting the pneumatic motor and the bit assembly to permit transfer of rotational motion from the motor to the bit assembly and to permit translational movement of the bit assembly relative to the motor.

14. A drill tool as set forth in claim 13 wherein the drive shaft assembly and bit assembly have a splined interconnection.

15. A drill tool as set forth in claim 14 wherein the drive shaft assembly comprises a gear assembly operatively connecting the motor to the bit assembly for reducing rotational speed imparted from the motor to the bit assembly, the bit assembly moving away from the gear assembly when moving to the extended position.

16. A drill tool as set forth in claim 15 wherein the bit assembly includes a chuck for receiving a bit to remove a spot weld.

17. A drill tool as set forth in claim 13 further comprising a piston defining at least a portion of the air chamber.

18. A drill tool as set forth in claim 17 further comprising an air intake, the air intake introducing air into the air chamber when the drill tool is activated, the air introduced into the air chamber causing the piston to move the bit assembly to the extended position.

19. A drill tool as set forth in claim 18 wherein air from the air intake drives the pneumatic motor to power the bit assembly after the piston moves the bit assembly to the extended position.

20. A drill tool as set forth in claim 19 further comprising a return spring, the return spring moving the piston and bit assembly from the extended position to the retracted position when the drill tool is deactivated and air ceases moving from the air intake into the air chamber.

21. A drill tool as set forth in claim 20 wherein the bit assembly is coupled to the piston to allow conjoint movement of the piston and bit assembly in the longitudinal direction of the housing independent of the motor and to allow rotational movement of the bit assembly relative to the piston.
